(19) United States
(12) Patent Application Publication
(10) Pub. No.: US 2013/0151386 A1
(43) Pub. Date: Jun. 13, 2013

(54) Service Delivery in Networks

(71) Applicants: Viren Malaviya, Cupertino, CA (US); Sanjeev Ukhalkar, Fremont, CA (US); Anand Oswal, Pleasanton, CA (US); Kiritkumar B. Joshi, Cupertino, CA (US); Aniruddha Atale, Magarpatta City (IN)

(72) Inventors: Viren Malaviya, Cupertino, CA (US); Sanjeev Ukhalkar, Fremont, CA (US); Anand Oswal, Pleasanton, CA (US); Kiritkumar B. Joshi, Cupertino, CA (US); Aniruddha Atale, Magarpatta City (IN)

(73) Assignee: CISCO TECHNOLOGY, INC., San Jose, CA (US)

(21) Appl. No.: 13/324,493

(22) Filed: Dec. 13, 2011

(51) Int. Cl. G06Q 10/06; H04W 12/06; G06Q 40/00; H04L 9/32

(52) U.S. Cl. 705/35; 705/1.1

(57) ABSTRACT

A method for providing access to a service using a network is implemented by establishing an agreement between an enterprise and a network service provider administering a network. Based on establishing the agreement, information is received from the network service provider on network resources configured to enable access to the service provided by the enterprise. A request to access the service is received from a network device via the network. The identity of the user associated with the network device is verified. Based on successfully verifying the identity of the user, the network device is sent information on the network resources. A service connection is established between the network device and the enterprise using the network resources that are configured to enable access to the service. The network device is allowed access to the service over the service connection.

### TECHNICAL FIELD

The following disclosure relates generally to delivering services in networks.

### BACKGROUND

Network devices in wireless and wireline networks may have constraints on the data traffic they exchange. For example, the volume of data traffic may be limited by a network device's data plan, or the quality of experience may vary. It may be useful to provide services that facilitate data exchange without constraints placed by the data plan, or with consistent quality of service, or both.

### BRIEF DESCRIPTION OF THE FIGURES

FIG. 1 illustrates an example of a system for providing service delivery to network devices in a network.

FIG. 2 illustrates an example of a system for providing service delivery by an enterprise to network devices in a network.

FIG. 3 is a flow chart illustrating an example of a process for providing services to network devices based on a Service Level Agreement (SLA) with a network service provider.

FIG. 4 is a flow chart illustrating an example of a process for a network device to access a service from an enterprise over a service connection.

FIG. 5 is a flow chart illustrating an example of a process for enabling an enterprise service connection based on a SLA.

### DESCRIPTION OF EXAMPLE EMBODIMENTS OVERVIEW

In a general aspect, a method for providing access to a service using a network is implemented by establishing an agreement between an enterprise and a network service provider administering a network. The enterprise is associated with a system including a processor configured for providing a service.

Based on establishing the agreement, information is received from the network service provider on network resources that are configured to enable access to the service provided by the enterprise. A request to access the service provided by the enterprise is received from a network device via the network.

The identity of the user associated with the network device is verified. Based on successfully verifying the identity of the user, the network resources associated with the network service provider of the network device that are configured to enable access to the service provided by the enterprise are determined. The network device is sent information on the network resources.

A service connection is established between the network device and the enterprise using the network resources associated with the network service provider of the network device that are configured to enable access to the service provided by the enterprise. The network device is allowed access to the service provided by the enterprise over the service connection.

Particular implementations may include one or more of the following features. The service request may include credentials of a user associated with the network device, and information on the network service provider of the network device such that the identity of the user may be verified based on the credentials included in the service request. The information provided in the service request may identify the service provider of the network device.

The network may be a wireless network. The network service provider may be a cellular network service provider. The network resources may include an Access Point Name (APN). The agreement may be a Service Level Agreement (SLA).

Receiving information from the network service provider on network resources that are configured to enable access to the service provided by the enterprise may include generating an application to include information associated with the dedicated network resources. The application may be configured to be used on a plurality of network devices. Information on the application may be provided on a website.

Allowing the network device access to the service provided by the enterprise over the service connection may include allowing the network device to access the service without constraints of a data plan that is provided to the network device by the network service provider. The agreement may include an arrangement between the enterprise and the network service provider for managing a financial cost of allowing the network device access to the service without billing the user associated with the network device. Allowing the network device access to the service provided by the enterprise over the service connection may further include providing the network device with a consistent quality of service (QoS) while accessing the service provided by the enterprise.

An application may be enabled on the network device. The application may be configured to be used to access the service provided by the enterprise. A first connection between the network device and the enterprise may be established using the application. A request to access the service provided by the enterprise may be sent to the enterprise using the application and over the first connection. Information on the network resources associated with the network service provider of the network device that are configured to enable access to the service provided by the enterprise may be received from the enterprise.

Based on receiving information on the dedicated network resources, a service connection between the network device and the enterprise may be established using the application. The service connection may be established using the network resources indicated in the information. The service provided by the enterprise may be accessed using the application and over the service connection. The application may be downloaded on to the network device from a website associated with the enterprise. The application may be provided on the website by the enterprise.

Based on establishing the agreement, one or more network resources included in the network may be configured for enabling service connections to the enterprise. A limit may be determined on network devices for which service connections to the enterprise may be enabled at a same time. Information on the one or more configured network resources may be sent to the enterprise.

A request may be received from a network device to establish a service connection to the enterprise using at least one of the configured network resources. It may be determined whether a number of network devices with enabled service connections to the enterprise are at the limit. Based on determining that the number of network devices with enabled service connections to the enterprise are below the limit, a service connection to the enterprise may be enabled using at least one of the configured network resources. The service connection may enable network traffic exchange without constraints of a data plan provided to the network device by the network service provider. The enterprise may be charged for a cost of the network traffic exchanged over the service connection. Based on determining that the number of network devices with enabled service connections to the enterprise are at the limit, the request from the network device may be denied such that a service connection from the network device to the enterprise is not enabled.

In another general aspect, a method for providing access to a service using a network is implemented by establishing an agreement by an enterprise with a network service provider administering a network. The enterprise is associated with a system including a processor configured for providing a service.

Based on establishing the agreement, a subscriber identity module (SIM) card is received from the network service provider. The SIM card includes information on network resources associated with the network service provider that are configured for enabling access to the service provided by the enterprise. The SIM card is provided to a user for enabling the user to access the service provided by the enterprise.

Particular implementations may include one or more of the following features. The user may insert the SIM card into a network device associated with the user. The network resources associated with the network service provider that are configured for enabling access to the service provided by the enterprise may be determined based on information included in the SIM card. A service connection may be established between the network device and the enterprise. The service connection may be established using the dedicated network resources. The service provided by the enterprise may be accessed using the network device and over the service connection. Based on the agreement, the service may accessed without constraints of a data plan provided to the network device by the network service provider, and the enterprise may be charged for a cost of network traffic exchanged over the service connection.

In yet another general aspect, a method for providing access to a service using a network is implemented by establishing an agreement between an enterprise and a network service provider administering a wireline network. The enterprise is associated with a system including a processor configured for providing a service.

A service connection request to a server associated with the enterprise is received at a name server associated with the wireline network. The connection request includes an address for the server. Responsive to receiving the connection request, an answer record is sent from the name server. The answer record includes additional data for configuring the connection based on the agreement.

The service connection is established through a router associated with the wireline network. The router is configured, based on the additional data included in the answer record, to allow network traffic over the service connection without constraints of a data plan provided to the network device by the network service provider. The enterprise is charged for a cost of the network traffic exchanged over the service connection.

### DETAILED DESCRIPTION OF EXAMPLE EMBODIMENTS

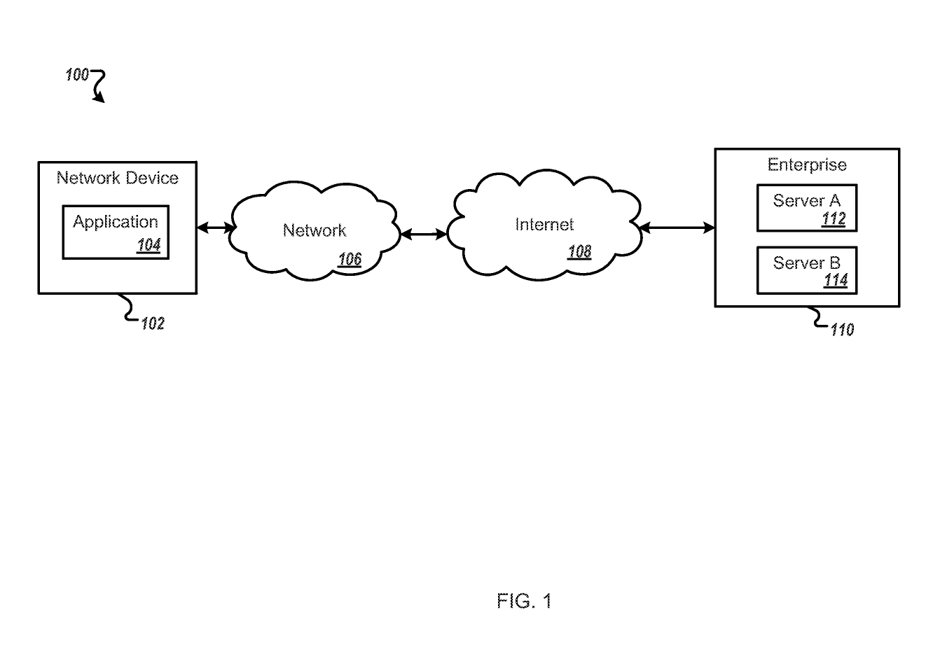

FIG. 1 illustrates an example of a system 100 for providing service delivery to network devices in a network. The system 100 includes a network device 102 that uses an application 104 to communicate over network 106 with enterprise 110. The network may be connected to the enterprise 110 via the Internet 108. Enterprise 110 runs server A 112 and server B 114 for providing services to the network device 102.

The network device 102 is a processing device configured with hardware and software that enables the device to interface with a user and run software applications to perform various processing tasks. The network device 102 may be a wireless or a wired device. The network device 102 is further configured to establish connections with other devices and servers using wired or wireless technology over the network 106 that allow the network device 102 to transmit and/or receive multimedia data. One or more software applications can be launched on the network device 102 that allows the network device 102 to process the multimedia data. The network device 102 may be a general purpose computer, e.g., a desktop computer or a laptop computer, an e-book reader, a music player, a tablet computer, a smart phone, or any other appropriate portable or stationary computing device. For example, the network device 102 may be a smart phone that is configured to run applications on the phone to access data, services, or both from remote sites over the network 106. The data may include content provided by a website in the World Wide Web (WWW), files stored in a remote server, or information from workplace servers. The services may include accounting or billing information from enterprise servers (e.g., a credit card company), or customer services provided by companies through web or voice sites.

A user of the network device 102 uses application 104 on the network device 102 to access the data, services, or both from remote sites over the network 106. For example, the user may select a graphically displayed icon on a graphical user interface (GUI) of the network device 102 to thereby invoke application 104 stored in the network device 102 with which the user can interact to access the data, services, or both. The application 104 may be a software process capable of interacting with remote servers over the network 106. In some implementations, the application 104 may be a conventional smart phone application that is provided by an enterprise, e.g., enterprise 110, to enable interaction with servers managed by the enterprise.

In one example implementation, the network 106 is a wireless network. The wireless network 106 may include a cellular network that is configured to handle both voice and data communications. For example, the wireless network 106 may be a Third Generation (3G) or Fourth Generation (4G) mobile telecommunications networks capable of supporting technologies such as Universal Mobile Telecommunications System (UMTS), Wideband Code Division Multiple Access (W-CDMA), High Speed Packet Access (HSPA), Evolved High-Speed Packet Access (HSPA+), Worldwide Interoperability for Microwave Access (WiMAX) or 3GPP Long Term Evolution (LTE). The wireless network 106 can also be an IEEE 802.11 network, a packet-switched data network, or any other network able to carry data.

In another example implementation, the network 106 is a wireline network, also referred to as a wired network. The wireline network 106 may include a cable network or a fiber optic network supporting Ethernet technology and configured to handle both voice and data communications.

In some implementations, the network 106 connects to remote enterprise servers, such as server A 112 or server B 114, through the Internet 108. In other implementations, the network 106 is directly connected to remote enterprise servers.

The Internet 108 may include one or more of a packet-switched data network, or any other network able to carry data, for example, Internet Protocol (IP)-based or asynchronous transfer mode (ATM)-based networks, including wired or networks. In some implementations, the Internet 108 may include the network 106. The Internet 108 and the network 106 may be configured to handle voice and data traffic. The data traffic includes web traffic, such as hypertext transfer protocol (HTTP) traffic and hypertext markup language (HTML) traffic, and File Transfer Protocol (FTP) traffic.

In general, the Internet 108 may include Wide Area Networks (WANs), Local Area Networks (LANs), analog or digital wired and networks (e.g., IEEE 802.11 networks, Public Switched Telephone Network (PSTN) with Integrated Services Digital Network (ISDN), and Digital Subscriber Line (xDSL)), Third Generation (3G) or Fourth Generation (4G) mobile telecommunications networks, a wired Ethernet network, a private network such as an intranet, radio, television, cable, satellite, and/or any other delivery or tunneling mechanism for carrying data, or any appropriate combination of such networks.

The enterprise 110 may be a corporate entity, an educational or non-profit institution, or any other appropriate organization. The enterprise 110 includes one or more hardware and software resources, such as processors and memory for storage, that allow the enterprise 110 to execute various instructions for providing services to users of devices, such as network device 102. The enterprise 110 manages one or more servers, such as server A 112 and server B 114, to provide the services to users. For example, enterprise 110 may be the workplace of the user of network device 102, who remotely accesses workplace data hosted on servers managed by enterprise 110 using the application 104 on network device 102. As another example, enterprise 110 may be a corporate service provider who manages business and customer services for corporate clients and hosts the data for the corporate clients on server A 112 and server B 114. In one example implementation, the enterprise 110 may manage a server farm for hosting services for multiple clients. The corporate service provider facilitates remote access, over the network 106 and Internet 108, to the data hosted on server A 112 and server B 114 by the corporate clients using the application 104 running on network device 102.

Server A 112 and server B 114 include computers running one or more software processes that are configured to provide services to clients using the application 104 running on network device 102. In one implementation, server A 112 and server B 114 may include similar hardware and software configuration and may run similar software processes providing similar services. However, in other implementations, server A 112 and server B 114 may have different hardware or software configurations, run different software processes and provide different services, or any suitable combination of the above. For example, server A 112 may provide business services, such as data storage and backup, while server B 114 may provide supporting services such as customer support.

As mentioned previously, the user of network device 102 launches application 104 to connect to access services hosted on server A 112 or server B 114 or both. When the application 104 is launched, one or more data connections are established between the application 104 and one or more of server A 112 and server B 114. The data connection is established through the network 106 and the Internet 108.

Upon establishing the data connection, the user of network device 102 accesses data that is hosted in the remote servers A 112 or B 114 or both. The user of network device 102 may use application 104 to access the data hosted in the remote servers. In an alternative implementation, the application 104 may be used to establish the connection between the network device 102 and the remote servers hosted by the enterprise 110, while the user of network device 102 utilizes some other suitable application on network device 102 to access the data hosted on the remote servers.

When the user of network device 102 accesses data hosted on the servers A 112 or B 114, data traffic is exchanged between the network device 102 and server A 112 or B 114. The data traffic exchange is facilitated by the resources provided by the network 106, in addition to the resources provided by the Internet 108. The network 106 may be managed by a service provider. The service provider of network 106 may include one or more hardware and software resources, such as processors and memory for storage, that allow the service provider to execute various instructions for managing the network 106.

The service provider of network 106 may have contracts with users, such as user of network device 102, specifying the volume of data (e.g., measured in units of bytes such as megabyte or gigabyte) that a user may exchange over the network 106 in a certain time period, and the financial cost that may be charged to the user for utilizing the network resources for the data exchange. For example, the contract may specify that user of network device 102 is allowed to consume 2 gigabytes of data in a month, and the service provider will bill the user $30 every month for the 2 gigabytes of data, while for every additional gigabyte of data consumed monthly by the user of network device 102, the service provider will bill the user an additional $10.

In one example implementation, the service provider of the network 106 sends a monthly bill to the user of network device 102, charging the user an appropriate amount of money based on the volume of data consumed by the user in the previous month, and following the financial cost structure specified in the contract. However, in some implementations, the enterprise 110 establishes an agreement with the service provider of network 106 such that the service provider does not bill the user of the network device 102 for the data that is exchanged between the network device 102 and the servers hosted by the enterprise 110. Instead, the service provider bills the enterprise 110 for the data exchanged between the network device 102 and the servers hosted by the enterprise 110, based on the terms of the agreement. In yet some other implementations, the service provider of network 106 establishes contracts or agreements with the user of network device 102 and the enterprise 110 such the both the user of the network device 102 and the enterprise 110 are billed for portions of the data traffic exchanged between the network device 102 and the enterprise 110, using the resources of the network 106.

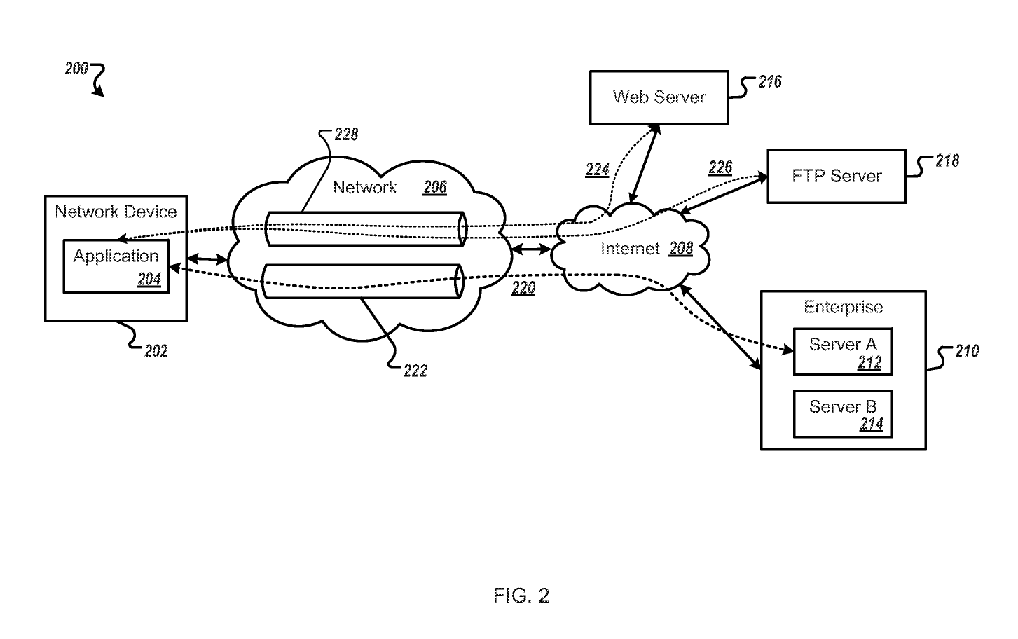

FIG. 2 illustrates an example of a system 200 for providing service delivery by an enterprise to network devices in a network. The system 200 may be similar to the system 100. The following sections describe the system 200 as being implemented and used by components of the system 100. However, the system 200 also may be implemented and used by other systems or system configurations.

The system 200 includes a network device 202 running an application 204. The network device 202 communicates over network 206 with enterprise 210, web server 216 and FTP server 218. The network 206 is connected to the enterprise 210, web server 216 and FTP server 218 via the Internet 208. Enterprise 210 runs server A 212 and server B 214 for providing services to the network device 202. Network device 202 connects with server A 212 or server B 214 via connection 220, which uses a section 222 of network 206. Network device 202 establishes connections 224 and 226 with web server 216 and FTP server 218 respectively, where the connections 224 and 226 uses a section 228 of network 206.

The network device 202 is similar to the network device 102. The network device 202 may be a general purpose computer, e.g., a desktop computer or a laptop computer, an e-book reader, a music player, a tablet computer, a smart phone, or any other appropriate portable or stationary computing device.

The application 204 is similar to the application 104. A user of network device 202 uses application 204 to access the data, services, or both from remote sites over the network 206. For example, the application 204 may be a smart phone application that enables user of network device 202 to exchange data, or utilize services, or both that are hosted on servers A 216 and B 218 in enterprise 210.

The network 206 is similar to the network 106 and may include wireless networks such as a cellular network supporting 3G or 4G technologies. Alternatively, the network 106 may be a wireline network such as a fiber optic network supporting Ethernet technology. The Internet 208 is similar to the Internet 108 and may include one or more of a packet-switched data network, or any other network able to carry data, for example, Internet Protocol (IP)-based or asynchronous transfer mode (ATM)-based networks, including wired or networks. In some implementations, the Internet 208 may include the network 206.

The enterprise 210 is similar to the enterprise 110. Enterprise 210 manages one or more servers A 212 and B 214 to provide services to users of devices, such as network device 202. Servers A 212 and B 214 are similar to servers A 112 and B 114 respectively. Servers A 212 and B 214 are configured to provide services to clients using the application 204 running on network device 202.

In one implementation, system 200 includes web server 216 and FTP server 218. Web server 216, or FTP server 218, or both, may be standalone servers that are distinct and separate from enterprise servers A 212 and B 214. However, in some implementations, web server 216, or FTP server 218, or both, are included in the servers that are managed by the enterprise 210. In such implementations, server A 212, server B 214, web server 216 and FTP server 218 may be co-located or they may be in physically distinct locations associated with the enterprise 210.

Web server 216 is a server that is configured to host a web site accessible by the network device 202 via WWW. Network device 202 accesses the content provided by the web site hosted by web server 216 by establishing a HTTP connection using the network 206 and the Internet 208. FTP server 218 is another remote server hosting files that are accessible by the network device 202 using the FTP protocol.

Network device 202 may access the website content provided by web server 216 or the files hosted at FTP server 218 using one or more applications that are different from the application 204. However, in some implementations, the application 204 is configured such that network device 202 can access the website content provided by web server 216 or the files hosted at FTP server 218 using the application 204, apart from being able to access the services provided by servers A 212 and B 214 using the same application 204.

The network 206 is managed by a service provider, e.g., a cellular network service provider or a broadband cable service provider. Similar to the contract between the user of network device 102 and the service provider of network 106, there may exist a contract between the user of network device 202 and the service provider of network 206 that mentions a volume of data that the network device 202 may exchange over the network 106 in a certain time period (e.g., a month) and the financial cost that may be charged to the user for utilizing the network resources for the data exchange. The contract between the user of network device 202 and the service provider of network 206 is henceforth referred to as the data plan for the network device 202. In some implementations, in addition to mentioning the data volume and financial cost structure, the data plan includes other parameters such as a minimum quality of service (QoS) that is guaranteed for the network device 202.

The enterprise 210 also establishes an agreement, such as a service level agreement (SLA), with the service provider of network 206. The agreement is executed and stored using servers associated with the enterprise 210 and the service provider of network 206. Based on the SLA, the service provider of the network 206 may agree that when network device 202 accesses data traffic that is provided by servers managed by enterprise 210, e.g., servers A 212 or B 214, the volume of the data traffic will not be counted against the data volume allocated to the network device 202 based on the network device's data plan. In addition, service provider may agree that the user of network device 202 will not be billed by the service provider for the data traffic exchanged with the servers managed by the enterprise 210. The SLA may mention that instead of the user of the network device 202, the enterprise 210 may bear the financial cost when the network device 202 exchanges data with servers managed by enterprise 210, such that the service provider of network 206 will bill the enterprise 210 when the network device 202 utilizes the resources of the network 206 to exchange data with the servers managed by enterprise 210. The SLA also may mention that the network 206 will provide a certain QoS to the connection between the network device 202 and the servers managed by the enterprise 210.

In some implementations, the network 206 may a wireless network. Based on the SLA, the service provider of wireless network 206 configures one or more network resources, e.g., gateways, routers and switches, in the wireless network 206. In one example implementation, the service provider creates a service definition call Access Point Name (APN) for enabling connections to the enterprise 210 based on the SLA. In this context, an APN is a configurable network identifier that enables the network device 202 to access the packet switched network provided by wireless network 206, and thus establish a connection with remote servers, such as servers A 212 or B 214, web server 216 or FTP server 218.

The service provider configures the one or more network resources such that when a connection is established between the network device 202 and the servers managed by enterprise 210 using the configured network resources, the SLA is applied to the connection. Consequently, the network device 202 is not constrained by the volume limit of its data plan for the connection. The network device 202 also is not charged for the connection and the connection is provided a certain QoS such that the user of network device 202 receives a consistent quality of experience. Based on the SLA, the service provider of wireless network 206 charges the enterprise 210 for the data volume exchanged over the connection. Such a connection is henceforth referred to interchangeably as a service connection or a SLA-configured connection.

The service provider sends information on the SLA-configured resources to the enterprise 210. In one implementation, the enterprise 210 configures an application to include information on the SLA-configured resources in wireless network 206, and publishes the application on a website associated with the enterprise 210. The user of network device 202 accesses the website associated with the enterprise 210 and downloads the application on to the network device 202 as application 204. Subsequently, when the user launches application 204 on the network device 202, the application 204 requests the wireless network 206 to establish a connection with either of server A 212 or B 214 using the SLA-configured resources included in the application. Based on the application request, the wireless network 206 creates a service connection between the network device 202 and either server A 212 or B 214 using the SLA-configured resources.

In one example implementation, the enterprise 210 includes the APN provided by the service provider in the application 204. Consequently, when the application 204 is launched on the network device 202, the application 204 requests a connection to the enterprise server A 212 or B 214 using the provided APN service. Based on the application request, the wireless network 206 creates a SLA-configured packet data service connection (PDSC) between the network device 202 and either server A 212 or B 214 using the configured APN. Data exchanged over the PDSC is subjected to the SLA such that the data is not constrained by the data plan of network device 202, the PDSC receives a certain QoS, the enterprise 210 is charged for the data exchange, or any suitable combination of the above.

In another implementation, the enterprise 210 does not configure an application with information on the SLA-configured resources in wireless network 206. Instead, the enterprise 210 updates server A 212 or B 214 or both with information on the SLA-configured network resources. When the user launches application 204 on the network device 202, a standard data connection is established between the network device 202 and the enterprise server A 212 or B 214. The standard data connection may be subject to the data plan of the network device 202.

The user provides login information, e.g., username and password, to the application 204 that is conveyed to server A 212 or B 214 over the standard data connection, along with a request from the application 204 to establish a service connection to the enterprise server. The application may also implicitly convey to the enterprise server information on the location of the network device 202, the identification of the wireless network 206, or any other suitable information that facilitates establishment of a service connection. The login information may have been previously provided by the user to the enterprise 210, e.g., when registering a user profile with the enterprise 210.

The enterprise server at the other end of the connection validates the user based on the login information conveyed by the application 204. In addition, based on the information on the location of the network device 202 and the identification of the wireless network 206, the enterprise server determines which network resources the application 204 should use for establishing the service connection. This may be the case, for example, when the enterprise 210 has different SLAs with different network service providers. Alternatively, this may be the case when enterprise 210 has different SLAs with the same service provider. For example, different network devices may have different agreements with the enterprise 210 that allowed the different network devices to access different services provided by the enterprise 210. Having different SLAs with the same service provider may provide a greater degree of granularity to the level of service that is afforded to different users. For example, the different SLAs may include varying limits on the amount of data that can be exchanged between network devices and the enterprise 210 without being subjected to the data plan of the respective network devices. The different SLAs also may include varying QoS guarantees for different network devices.

Upon determining the network resources the application 204 should use, the enterprise server sends a response to the request from the application 204 including the information on the SLA-configured network resources. The application 204 receives the information on the SLA-configured network resources and requests the wireless network 206 to establish a service connection with the enterprise server using the SLA-configured resources. Based on the application request, the wireless network 206 creates a service connection between the network device 202 and either server A 212 or B 214 using the SLA-configured resources, as described previously. Subsequent communications between the network device 202 and the enterprise server may take place over the service connection. In some implementations, the previously established standard data connection is not used once the service connection is established, and therefore the standard data connection can be terminated.

The service connection between the network device 202 and the enterprise server is subjected to the SLA between the service provider of the wireless network 206 and the enterprise 210 for the section of the service connection that is over the wireless network 206. For example, for the service connection 220, the section 222 is subjected to the SLA. However, the section of the connection 220 that is over the Internet 208 may not subjected to the SLA since the Internet 208 may be managed by an entity different from the service provider of the wireless network 206.

As described previously, apart from the service connection 220, the network device 202 establishes standard data connections 224 and 226 with the web server 216 and FTP server 218 respectively. The connections 224 and 226 may overlap in the same section 228 of the wireless network 206, that is, they may use the same network resources in the wireless network 206. The data exchanged between network device 202 with the web server 216 and FTP that is transferred over the section 228 in wireless network 206 are subject to the constraints of the data plan for the network device 202. This may be the case, for example, because the web server 216 or FTP server 218 may not have SLAs with the service provider of wireless network 206 and therefore the resources in the section 228 may not be configured for any SLA.

In some implementations, the sections 228 and 222 utilize the same resources in the wireless network 206, but even in such cases, the data transferred over section 228 may be subject to the data plan of network device 202, while the data transferred over section 222 may be subject to the SLA between the service provider and the enterprise 210. This may be the case, for example, because the network resources in the wireless network 206 may be configured to distinguish between the different connections based on determining the network addresses of the servers at one end of the connections. By examining the headers of data packets (e.g., by performing deep-packet inspection), the network resources can identify the server addresses.

In other implementations, the network 206 may be a wireline network and the network device 202 may be a wireline device. The wireline network 206 establishes an SLA with the enterprise 210 as described previously. Based on the SLA, the wireline network 206 configures network resources such as Domain Name Servers (DNS), routers and switches to facilitate service connections to the servers managed by the enterprise 210. In such implementations, in order to connect to a remote server, e.g., server A 212 or B 214, the user of the network device 202 may type in a Uniform Resource Locator (URL) of the remote server in a web browser on the network device 202. A connection request from the network device is sent to a SLA-configured DNS associated with the network 206 to resolve the domain associated with the published URL. The DNS responds with an Answer record that includes a network address for the remote server. In order to facilitate the connection as a service connection, the DNS also includes in the Answer record additional data that instructs the SLA-configured network resources, e.g., routers and switches, that the service for the given network address should not be counted against the service profile or data plan of the network device 202. The additional data in the Answer record may further indicate that number bytes consumed by the network device is chargeable and accountable to the third party enterprise 210 associated with the remote server that the network device 202 is contacting using the published URL. In addition, the Answer record may indicate that the service connection is to be afforded a certain data rate based on the SLA.

The service connection from the network device 202 to an enterprise server is established through the network 206 using the information included in the Answer record. An SLA-configured network router that is in the path of the service connection may determine the volume of data traffic consumed in the service connection, but it will not deducted from the quota allocated to the network device 202 based on the data plan. Instead, the network service provider may the charge the enterprise 210 for the data traffic. The network router also may allow a higher data rate for the service connection based on the information provided in the Answer record.

In an alternative implementation, when an enterprise server initially interacts with a network device 202, the enterprise server sends information on the throughput or data rate that the network device 202 may have. The information is received by the SLA-configured network routers in the path of the service connection. The network routers perform deep packet inspection to determine the information sent by the enterprise servers. Based on the information on the throughput, the network routers allow a higher data rate for the service connection.

As described in the preceding sections, the system 200 has the advantage that, by utilizing SLAs between an enterprise and a network service provider, the system 200 enables a network device to access data services over a network without being constrained by volume limits specified in the network device's data plan, or without being billed for the consumed data. In addition, a QoS may be provided to the network device that otherwise would not be guaranteed. Such a system can make it convenient for a user of network device 202 to use data services from the enterprise 210 without worrying about data plan limits or slow/dropped connections. For example, the user may be able to work efficiently for extended periods from a remote location using the network device 202 to connect to workplace server hosted by enterprise 210.

An additional advantage of the system 200 is that in some implementations, the enterprise 210 provides a proxy service to the network device 202, thereby enabling the network device 202 to access WWW websites or other remote servers without having to pay data plan charges. For example, the user of network device 202 may initially use application 204 for establishing a service connection as described previously. Subsequently the user may user application 204, or some other application on the network device 202 with the application 204 running in the background, to establish a HTTP connection with a website, or a FTP connection with a file server, over the service connection. The HTTP connection is routed through the enterprise server with whom the service connection is established. For example, the network device 202 may establish a HTTP connection with web server 216, or a FTP connection with FTP server 218, that is established over the service connection 220. Therefore, the HTTP connection or the FTP connection would use the section 222, and be routed through the enterprise server A 212 or B 214 with which the service connection is established. In providing such a proxy service, the enterprise 210 may generate revenue, for example, by displaying advertisements on the network device 202 when the service connection is established. The advertisements may be displayed using the application 204, or some other application that is used to access the remote web server or FTP server.

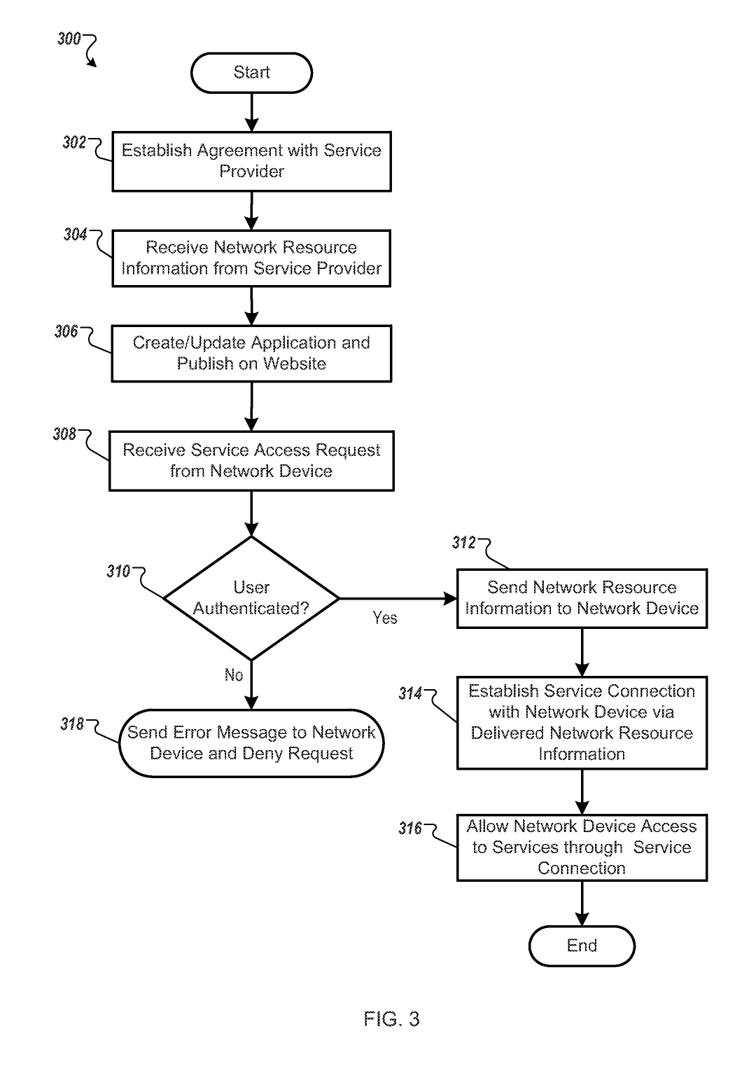

FIG. 3 is a flow chart illustrating an example of a process 300 for providing services to network devices based on an SLA with a service provider. The process 300 may be performed by an enterprise that provides access to data or services or both to network devices. For example, the process 300 may be performed by the enterprise 210. The following describes the process 300 as being performed by components of the system 200. However, the process 300 may be performed by other systems or system configurations.

The enterprise providing access to data or services to network devices establishes agreements with one or more service providers (302). The agreements are executed and stored using servers associated with the enterprise and the service providers. The service providers manage networks through which the network devices access the data or services provided by the enterprise. For example, the enterprise 210 makes a Service Level Agreement (SLA) with the service provider of the network 206. As described previously, based on the SLA, the service provider and the enterprise makes an arrangement that when a network device accesses data traffic from servers managed by enterprise 210, e.g., servers A 212 or B 214, the traffic volume will not be counted against the network device's data plan. In addition, the network device user will not be billed for the data traffic. Instead, the enterprise 210 bears the financial cost for the data exchanged with the enterprise servers, such that the service provider will bill the enterprise 210 for the data exchanged with the network device 202. The SLA also may mention that the network will provide a certain QoS to the connection between the network device and the enterprise servers.

In some implementations, the SLA may include different levels of service for different network devices, e.g., a different traffic volume allowed for the connection to the enterprise servers and varying QoS guarantees for the service connections. The SLA may mention that the financial cost charged to the enterprise will be different for different levels of service.

Upon establishing the agreement, the enterprise receives information on network resources from the service provider that are configured based on the SLA (304). For example, the service provider of network 206 configures one or more network resources based on the SLA and sends information on the SLA-configured resources to the enterprise 210. The SLA-configured resources may include, for example, a service definition call APN for use by network devices for creating service connections through the network 206 to the enterprise 210.

The enterprise creates or updates an application and publishes the application on a website associated with the enterprise (306). In one implementation, the application is configured with information on the SLA-configured network resources provided by the service provider. In other implementations, the application is configured to enable a standard data connection to the enterprise servers. The network device using the application can use the standard data connection to request a service connection to the enterprise servers.

A network device, e.g., network device 202, uses the application to establish a data connection with the enterprise 210 through the network 206. At the enterprise end, the data connection is with a server managed by the enterprise, e.g., server A 212 or B 214. The enterprise receives a request from the network device to allow service access to the network device (308). For example, the application 204 launched on the network device 202 sends a request, over the standard data connection that is established, to connecting enterprise server A 212 or B 214 to establish a service connection to the enterprise server so as to access the data or services provided by the enterprise server. Along with the request, the application 204 conveys to server A 212 or B 214 login information, e.g., username and password, of the user of the network device 202. The application also may convey to the enterprise server information on the location of the network device 202, the identification of the network 206, or any other suitable information that facilitates establishment of a service connection.

The enterprise server authenticates the user based on the login information conveyed by the application 204 (310). For example, the user may have been previously provided login information to the enterprise 210 that is stored in memory by the enterprise 210. The enterprise 210 checks login information conveyed with the service connection request with the stored login information to confirm whether there is a match. If the login information conveyed with the service connection request does not match stored login information for any user, then the enterprise may determine that the user of network device 202 is not registered or not authorized to access the data or services provided by the enterprise. Consequently, the enterprise sends an error message to the network device and denies the service access request (318).

If there is a match, the enterprise determines that the user of network device 202 is registered to access the data or services provided by the enterprise. Based on the location information for the network device 202 and the network 206 identification that are conveyed by the application 204, the enterprise determines which network resources the application 204 should use for establishing the service connection. This may be the case, for example, when the enterprise 210 when network devices can connect to the enterprise using different networks. Alternatively, this may be the case when enterprise 210 has different SLAs with the same service provider for different users. Upon determining the appropriate network resources for the service access request, the enterprise sends a response to the network device including information on the network resources (312). For example, the enterprise 210 may send the SLA-configured APN as service data in response to the service access request by network device 202.

The network device receives the information on the SLA-configured network resources from the enterprise server and provides the network resources information to the network to establish a service connection with the enterprise server using the SLA-configured network resources. Based on the application request, the network creates a service connection between the network device and the enterprise server using the SLA-configured resources. Upon receiving the service connection information from the network, the enterprise server accepts the service connection request and thereby establishes a service connection with the network device via the network resource information that was delivered to the network device (314). For example, the application 204 on network device 202 uses the APN service data received from the enterprise server A 212 or B 214 to request the network 206 to establish an enterprise PDSC through which the network device will access the data or services provided by the enterprise. The enterprise PDSC is established between the network device 202 and either enterprise server A 212 or B 214 as a new data connection.

Once the service connection is established, the enterprise allows the network device access to services provided by the enterprise through the service connection (316). For example, once the enterprise PDSC is established between network device 202 and enterprise server A 212 or B 214, the network device is allowed access to the requested service over the PDSC with consistent quality of experience.

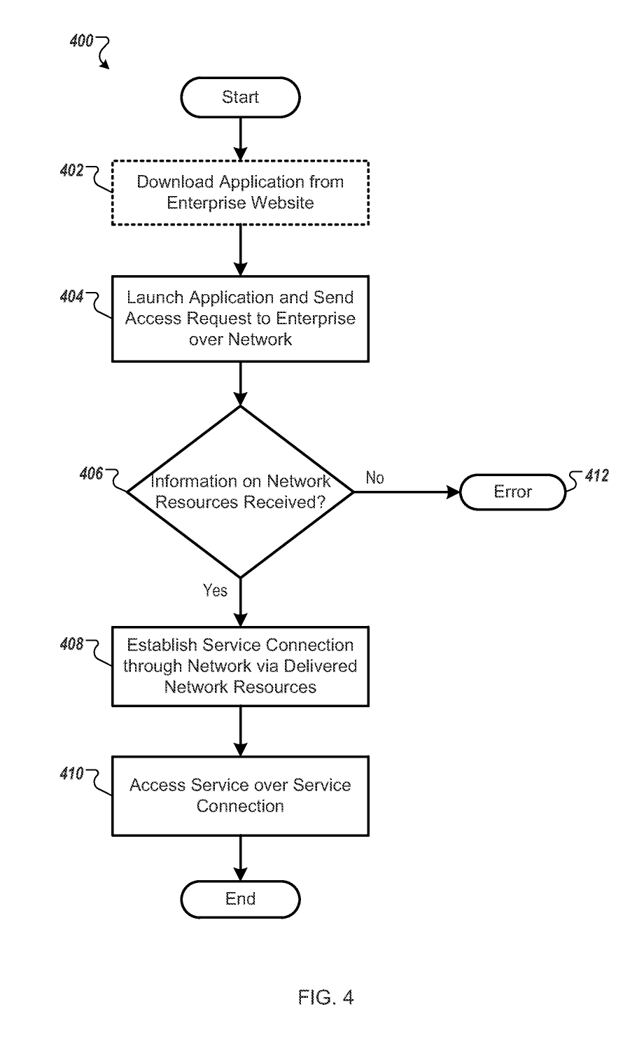

FIG. 4 is a flow chart illustrating an example of a process 400 for a network device to access a service from an enterprise over a service connection. The process 400 may be performed by a network device using an application to access data or services or both hosted by remote enterprise servers. For example, the process 400 may be performed by the network device 202. The following describes the process 400 as being performed by components of the system 200. However, the process 400 may be performed by other systems or system configurations.

The network device communicates with the enterprise servers using a software application. The application may be provided by the enterprise. As described previously, the enterprise may publish the application on a website associated with the enterprise. In some implementation, the application may not be included with the network device. Instead, the user of the network device may access the website associated with the enterprise and download the application from the website (402). For example, the user of network device 202 may visit a website associated with enterprise 210 and download the application 204. However, in other implementations, the application may be present on the network device (e.g., previously downloaded by the user, or the network device pre-configured with the application) and the user may not have to download the application from the enterprise website.

Subsequently, the user of the network device launches the application and sends a service access request to the enterprise through the network (404). For example, the user of network device 202 launches application 204 on the network device 202. The application 204 establishes a standard data connection with the enterprise server A 212 or B 214 through the network 206 and sends a request message to the connected enterprise server to access a service. The request message also may include login information provided by the user, location information of the network device 202, identification of the network 206, or any other suitable information that facilitates establishment of a service connection.

The connected enterprise server validates the user using the information conveyed by the application. Based on the validation by the enterprise server, the network device may receive information on network resources that are to be used for establishing a service connection (406). For example, network device 202 may receive a response message from the connected enterprise server that includes information on the SLA-configured network resources. However, in some implementations, the network device may receive an error message from the enterprise server, or may not receive a response, indicating an error condition (412). This may be the case, for example, when the enterprise server cannot find a match in its memory for the login information provided by the user of the network device. Alternatively, the information on the network, or the information on the location of the network device, or both, that are conveyed in the service access request message from the application 204 are erroneous.

In the event the network device successfully receives information on the SLA-configured network resources, the network device establishes a service connection with an enterprise server through the network using the delivered network resources (408). For example, upon receiving the network resources information from enterprise 210, application 204 requests the network 206 to establish a service connection with the enterprise server using the SLA-configured resources.

The network 206 creates a service connection between the network device 202 and either server A 212 or B 214 using the SLA-configured resources, as described previously.

Subsequent to establishment of the service connection, the network device accesses the requested service over the service connection (410). For example, the user of network device 202 may use application 204 to access data or services provided by the enterprise 210 through the service connection established over network 206. In some implementations, the application 204 may be initially used for establishing the service connection, but the user may enable some other application on the network device 202 to access the data or services from the enterprise 210 over the service connection. The application 204 may run as a background process on the network device 202.

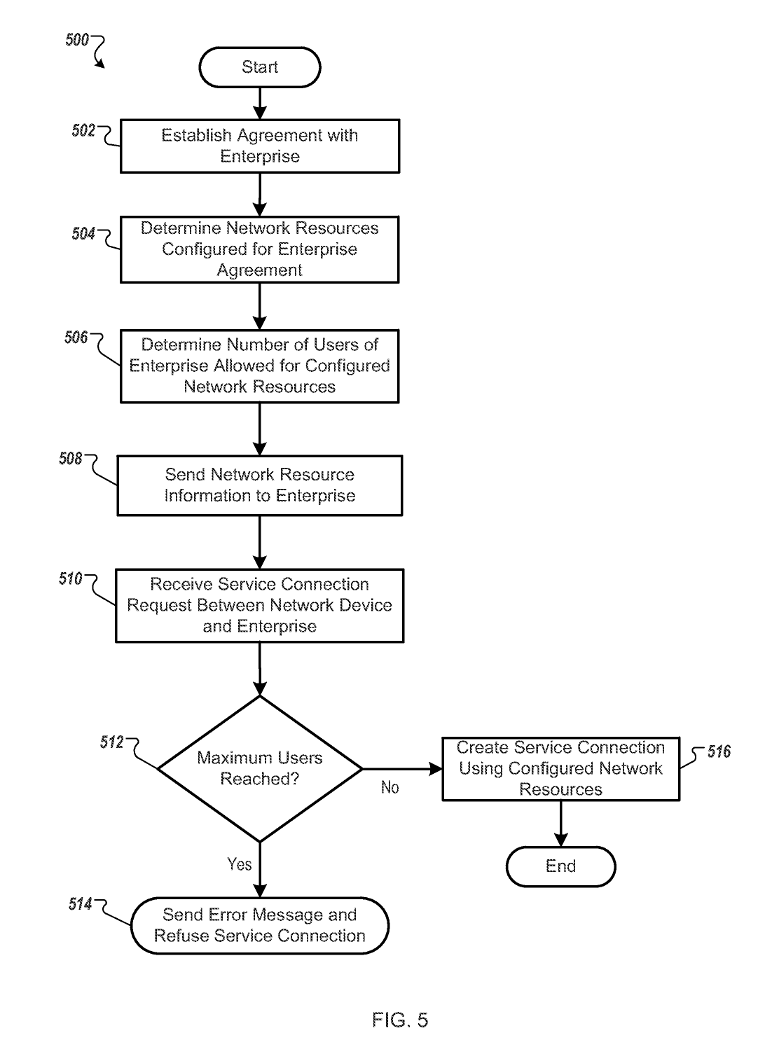

FIG. 5 is a flow chart illustrating an example of a process 500 for enabling an enterprise service connection based on a SLA. The process 500 may be performed by a service provider managing a network that is used to access services from an enterprise. For example, the process 500 may be performed by the network 206 service provider. The following describes the process 500 as being performed by components of the system 200. However, the process 300 may be performed by other systems or system configurations.

The service provider manages a network, e.g., network 206, which connects network devices to enterprise servers for accessing data or services provided by the enterprise. The service provider establishes an agreement with an enterprise providing services to network devices (502). The agreement is executed and stored using servers associated with the service provider and the enterprise. For example, the service provider of the network 206 makes a Service Level Agreement (SLA) with the enterprise 210 that provides services to network device 202. As described previously, based on the SLA, the service provider may make an arrangement that when network device 202 uses the network 206 to access data traffic from enterprise 210, the service provider will not subject the data traffic to the data plan that network device 202 has executed with the service provider. In addition, the user of the network device 202 will not be billed for the data exchange. Instead, the service provider will bill the enterprise 210. In some implementations, there may be multiple SLAs for different levels of service access, or a single SLA may include different levels of service for different network devices. For example, different network devices may be allowed different traffic volumes, or different levels of QoS guarantees for the service connections, based on different price structures for the level of subscription with the enterprise or the amount charged to the enterprise by the service provider.

Upon establishing the agreement, the service provider determines one or more network resources in the managed network that can be configured based on the agreement with the enterprise (504). For example, the service provider of network 206 may configure gateways, routers, switches, or any other suitable network resource, in the network 206 based on the SLA with enterprise 210. In one example implementation, the service provider may create a service definition call APN for enabling service connections to the enterprise 210. The service provider configures the network resources such that when a service connection is established between the network device 202 and the servers of enterprise 210 using the configured network resources, the SLA is applied to the service connection. Consequently, the bandwidth, throughput, or traffic amount of the service connection is not constrained by the limits of the data plan established by the network device 202 with the service provider, and the service connection is provided a QoS guaranteed based on the SLA such that the user of network device 202 receives a consistent quality of experience. The user is also not billed for the data exchanged over the service connection.

In addition to the network resources, the service provider determines the number of users requesting access to the enterprise through service connections that will be allowed for the configured network resources (506). For example, the service provider may determine that at a given time a maximum N users will be allowed for service connections to the enterprise servers. The number of users may be determined based on the terms of the SLA, e.g., the SLA may mention that the enterprise will bear the financial cost of N users' service connections in a given time period. Alternatively, or in addition to the terms of the SLA, the number of users may be determined based on the capacity of the enterprise servers or the configured network resources. For example, one or more routers in the network that are configured for the service connections may together have a maximum capacity of N connections at a given time, thereby placing an upper limit on how many connections can be active simultaneously. Similarly, the servers used by the enterprise for providing the services may have a combined capacity of servicing N connections at a time.

The service provider sends information on the network resources to the enterprise (508). For example, service provider of network 206 sends information on the network resources in network 206 to enterprise 210 that are configured based on the SLA between the service provider and the enterprise 210.

The service provider receives requests to facilitate service connections between network devices and the enterprise (510). For example, network device 202 uses application 204 to request a service connection with the enterprise 210 through the network 206. The network device 202 receives information on the SLA-configured network resources from the enterprise210 and provides the network resources information to the network 206 to establish the service connection using the SLA-configured network resources.

Upon receiving the request from the application, the network determines whether a maximum number of users with service connections for the enterprise has been reached (512). For example, the network resources in network 206 may check whether N number of service connections are active for the enterprise servers.

If the network determines that the maximum number of users have been reached, the network resources may not be able to create additional service connections. Instead, the network may send an error message to the requesting network device, with the error message indicating that the service connection request has been refused (514). However, if the maximum number of users have not been reached, then the network creates a service connection between the network device and the enterprise server using the SLA-configured network resources (516). For example, network 206 facilitates creation of a PDSC between network device 202 and server A 212 or B 214 of enterprise 210. The service connection is created using the network resources in network 206 that are configured based on the SLA between the service provider of network 206 and the enterprise 210. Once the service connection is established, the network device 202 accesses the services provided by the enterprise 210 through the service connection receiving a consistent quality of experience and without being charged for the usage.

Other implementations are within the scope of the present disclosure. In one example implementation, a service connection can be established with pre-provisioned Subscriber Identity Module (SIM) cards provided by the service provider of the network. In this context, a SIM card includes information related to a network and is inserted into a card slot or some other suitable receptacle coupled to a network device. When the network device attempts to connect with a destination, the information included in the SIM card facilitates establishment of the connection, e.g., a data or voice connection or both.

In the above example implementation, upon making an SLA with an enterprise, the service provider of the network configures one or more SIM cards that can be used by the enterprise users for establishing service connections to the enterprise servers. For example, the service provider programs the SIM cards with a dedicated APN for the enterprise. The service provider gives the SIM cards to the enterprise, which in turn provides the SIM cards to its users. Subsequently, a user who receives the SIM card couples the SIM card to his or her network device and establishes a service connection based on the information included in the SIM card.

Using pre-provisioned SIM cards as above may allow a user to establish a service connection without requiring to use an application, e.g., application 204. The service connection may be created as the default network connection for the network device using the pre-provisioned SIM card. All subsequent voice or data communications for the network device may be transferred over the service connection such that all communications are routed through the enterprise servers.

An additional advantage of providing SIM cards configured based on SLA is that such SIM cards may be used to establish service connections to the enterprise when the network device is in a network different from the network of the service provider that generated the pre-provisioned SIM cards. For example, the network associated with the pre-provisioned SIM card may be the home network for the network device, while other networks managed by different service providers may be foreign networks. The home network service provider may have an agreement with a foreign network service provider. When a connection is established from the foreign network using the pre-provisioned SIM card, the foreign network may recognize the connection as a service connection covered by the agreement with the home network service provider. Therefore, the foreign network may facilitate the service connection such that the same traffic volume, or QoS, or both, are afforded to the service connection, and the financial cost for the foreign network is charged to the home network service provider, instead of billing the user of the network device. In turn, the home network service provider may bill the enterprise for the cost charged by the foreign network, instead of billing the user of the network device.

The disclosed and other examples can be implemented as one or more computer program products, i.e., one or more modules of computer program instructions encoded on a computer readable medium for execution by, or to control the operation of, data processing apparatus. The implementations can include single or distributed processing of algorithms. The computer readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document describe many specifics, these should not be construed as limitations on the scope of an invention that is claimed or of what is claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features is described above as acting in certain combinations and even initially claimed as such, one or more features from a claimed combination can in some cases be excised from the combination, and the claimed combination is directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for providing access to a service using a network, the method comprising:
establishing an agreement between an enterprise and a network service provider administering a network, wherein the enterprise is associated with a system including a processor configured for providing a service;
based on establishing the agreement, receiving from the network service provider information on network resources that are configured to enable access to the service provided by the enterprise;
receiving, from a network device via the network, a service request to access the service provided by the enterprise;
verifying an identity of a user associated with the network device;
based on successfully verifying the identity of the user, determining the network resources associated with the network service provider of the network device that are configured to enable access to the service provided by the enterprise;
sending the network device information on the network resources;
establishing a service connection between the network device and the enterprise using the network resources indicated in the network device information; and
allowing the network device access to the service provided by the enterprise over the service connection.

2. The method of claim 1, wherein the service request includes credentials of a user associated with the network device and information on the network service provider of the network device such that
the identity of the user is verified based on the credentials included in the service request, and
the network service provider of the network device is identified using the information included in the service request.

3. The method of claim 1, wherein the network is a wireless network.

4. The method of claim 3, wherein the network service provider is a cellular network service provider.

5. The method of claim 4, wherein the network resources includes an Access Point Name (APN).

6. The method of claim 1, wherein the agreement is a Service Level Agreement (SLA).

7. The method of claim 1, wherein receiving from the network service provider information on network resources that are configured to enable access to the service provided by the enterprise comprises:
generating an application to include information associated with the network resources, wherein the application is configured to be used on a plurality of network devices; and
providing information on the application on a website.

8. The method of claim 1, wherein allowing the network device access to the service provided by the enterprise over the service connection comprises allowing the network device access to the service without constraints of a data plan that is provided to the network device by the network service provider.

9. The method of claim 1, wherein the agreement includes an arrangement between the enterprise and the network service provider for managing a financial cost of allowing the network device access to the service without billing the user associated with the network device.

10. The method of claim 1, wherein allowing the network device access to the service provided by the enterprise over the service connection comprises providing the network device with a consistent quality of service (QoS) while accessing the service provided by the enterprise.

11. The method of claim 1, further comprising:
enabling an application on the network device, wherein the application is configured to enable access to the service provided by the enterprise;
establishing, using the application, a first connection between the network device and the enterprise;
sending to the enterprise, using the application and over the first connection, a request to access the service provided by the enterprise;
receiving from the enterprise, information on the network resources associated with the network service provider of the network device that are configured to enable access to the service provided by the enterprise;
based on receiving the information on the network resources, establishing, using the application, a service connection between the network device and the enterprise, wherein the service connection is established using network resources indicated in the information; and
accessing, using the application and over the service connection, the service provided by the enterprise.

12. The method of claim 11, further comprising:
downloading the application on to the network device from a website associated with the enterprise, wherein the application is provided on the website by the enterprise.

13. The method of claim 1, further comprising:
based on establishing the agreement, configuring one or more network resources included in the network for enabling service connections to the enterprise;
determining a limit on network devices for which service connections to the enterprise may be enabled at a same time;
sending information on the one or more configured network resources to the enterprise;
receiving a connection request from a network device to establish a service connection to the enterprise using at least one of the configured network resources;
determining whether a number of network devices with enabled service connections to the enterprise are at the limit;
based on determining that the number of network devices with enabled service connections to the enterprise are below the limit, enabling a service connection between the network device and the enterprise using at least one of the configured network resources, wherein the service connection enables network traffic exchange without constraints of a data plan provided to the network device by the network service provider; and
charging the enterprise for a cost of the network traffic exchanged over the service connection.

14. The method of claim 13, further comprising:
based on determining that the number of network devices with enabled service connections to the enterprise are at the limit, denying the connection request from the network device such that a service connection from the network device to the enterprise is not enabled.

15. A method for providing access to a service using a network, the method comprising:
establishing, by an enterprise, an agreement with a network service provider administering a network, wherein the enterprise is associated with a system including a processor configured for providing a service;
based on establishing the agreement, receiving a subscriber identity module (SIM) card from the network service provider, wherein the SIM card includes information on network resources associated with the network service provider that are configured based on the agreement for enabling access to the service provided by the enterprise; and
providing the SIM card to a user for enabling the user to access the service provided by the enterprise.

16. The method of claim 15, further comprising:
inserting, by the user, the SIM card into a network device associated with the user;
based on information included in the SIM card, determining the network resources associated with the network service provider that are configured for enabling access to the service provided by the enterprise;
establishing a service connection between the network device and the enterprise using the network resources; and
accessing, using the network device and over the service connection, the service provided by the enterprise,
wherein, based on the agreement, the service is accessed without constraints of a data plan provided to the network device by the network service provider, and the enterprise is charged for a cost of network traffic exchanged over the service connection.

17. A method for providing access to a service using a network, the method comprising:
establishing an agreement between an enterprise and a network service provider administering a wireline network, wherein the enterprise is associated with a system including a processor configured for providing a service;
receiving at a name server associated with the wireline network, a service connection request from a network device to a server associated with the enterprise, wherein the connection request includes an address for the server;
responsive to receiving the connection request, sending an answer record from the name server, wherein the answer record includes additional data for configuring the connection based on the agreement;
establishing the service connection through a router associated with the wireline network, wherein the router is configured, based on the additional data included in the answer record, to allow network traffic over the service connection without constraints of a data plan provided to the network device by the network service provider; and
charging the enterprise for a cost of the network traffic exchanged over the service connection.

18. A computer program product, embodied in a non-transitory machine-readable medium and including instructions executable by a processor, the instructions operable to cause the processor to perform functions including:
establishing an agreement between an enterprise providing a service and a network service provider administering a network;
based on establishing the agreement, receiving from the network service provider information on network resources that are configured to enable access to the service provided by the enterprise;
receiving, from a network device via the network, a service request to access the service provided by the enterprise;
verifying an identity of a user associated with the network device;
based on successfully verifying the identity of the user, determining the network resources associated with the network service provider of the network device that are configured to enable access to the service provided by the enterprise;
sending the network device information on the network resources;
establishing a service connection between the network device and the enterprise using the network resources indicated in the network device information; and
allowing the network device access to the service provided by the enterprise over the service connection.

19. A computer program product, embodied in a non-transitory machine-readable medium and including instructions executable by a processor, the instructions operable to cause the processor to perform functions including:
enabling an application on a network device, wherein the application is configured to enable access to a service provided by an enterprise;
establishing, using the application, a first connection between the network device and the enterprise;
sending to the enterprise, using the application and over the first connection, a request to access the service provided by the enterprise;
receiving from the enterprise, information on network resources associated with a network service provider of the network device that are configured to enable access to the service provided by the enterprise;
based on receiving the information on the network resources, establishing, using the application, a service connection between the network device and the enterprise, wherein the service connection is established using network resources indicated in the information; and
accessing, using the application and over the service connection, the service provided by the enterprise.

20. A computer program product, embodied in a non-transitory machine-readable medium and including instructions executable by a processor, the instructions operable to cause the processor to perform functions including:
establishing an agreement between a network service provider administering a network and an enterprise providing a service;
based on establishing the agreement, configuring one or more network resources included in the network for enabling service connections to the enterprise;
determining a limit on network devices for which service connections to the enterprise may be enabled at a same time;
sending information on the one or more configured network resources to the enterprise;
receiving a connection request from a network device to establish a service connection to the enterprise using at least one of the configured network resources;
determining whether a number of network devices with enabled service connections to the enterprise are at the limit;
based on determining that the number of network devices with enabled service connections to the enterprise are below the limit, enabling a service connection between the network device and the enterprise using at least one of the configured network resources, wherein the service connection enables network traffic exchange without constraints of a data plan provided to the network device by the network service provider; and
charging the enterprise for a cost of the network traffic exchanged over the service connection.
